(19) United States
(12) Patent Application Publication
(10) Pub. No.: US 2025/0368928 A1
(43) Pub. Date: Dec. 4, 2025

(54) ALCOHOLIC DRINKS USING MAPLE SYRUP AS A RAW MATERIAL, AND METHODS FOR THE PREPARATION AND STORAGE THEREOF

(71) Applicant: YAN CHEN, APPLE HILL (CA)

(72) Inventor: YAN CHEN, APPLE HILL (CA)

(21) Appl. No.: 18/732,617

(22) Filed: Jun. 4, 2024

(51) Int. Cl. C12G 3/02; C12G 3/07; C12G 3/08; C12H 6/02

(52) U.S. Cl. CPC C12G 3/02; C12G 3/07; C12G 3/08; C12H 6/02

(57) ABSTRACT

The present disclosure provides alcoholic drinks using maple syrup as a raw material and methods for the preparation. The maple syrup, with its sugar concentration of 66% and its pristine and pure properties, stimulates an easy initiation of a fermentation, and the methods do not yield any waste or impurities after fermentation, which is more environmentally friendly. Additionally, the present disclosure employs a maple wood barrel storing and aging the alcoholic drink, augmenting the aroma and quality of the maple syrup wine further.

### FIELD

This disclosure relates to alcoholic drinks, and more particularly, to alcoholic drinks using maple syrup as a raw material, and methods for the preparation and storage thereof.

### BACKGROUND

The art of brewing has an extensive history, fundamentally involving the conversion of plants into sugars, which are then fermented to create alcohol. With the brewing industry's growth, a variety of materials ranging from grains to sugarcane molasses and different fruits are used in fermentation. However, traditional brewing faces significant challenges with the disposal of by-products and residues, posing potential environmental hazards. Specifically, the production of rum uses sugarcane molasses, a by-product of sugar manufacturing, which after fermentation generates difficult-to-treat waste that can pollute the environment.

Maple syrup, known for its high nutritional value, delightful sweet taste, and consistent quality, is traditionally consumed directly or used in baking, yet its potential in brewing remains underexplored. Although records suggest that maple water can be fermented to produce alcohol, there is a dearth of industrial-scale research and implementation. Our extensive review of historical documents and five years of experimental testing has shown that using maple water directly in concentrated fermentation can produce alcohol, but there are practical challenges due to its low sugar content and high levels of lignocellulose and other impurities, which make it prone to degradation.

The challenge lies in reducing the environmental impacts of traditional brewing methods while also developing new avenues for the deep processing and value enhancement of maple syrup, aiming to discover a brewing technique that is both enjoyable and environmentally sustainable.

### SUMMARY

In view of the above problems, alcoholic drinks using maple syrup as a raw material and methods for the preparation are provided in the present disclosure.

The maple syrup, with its sugar concentration of 66% and its pristine and pure properties, stimulates an easy initiation of a fermentation, and the methods do not yield any waste or impurities after fermentation, which is more environmentally friendly. Additionally, the present disclosure employs a maple wood barrel storing and aging the alcoholic drink (henceforth named ‘maple syrup wine’), augmenting the aroma and quality of the maple syrup wine further.

The present disclosure provides alcoholic drinks using maple syrup as a raw material, and methods for the preparation and storage. In some embodiments, an alcoholic drink, comprises: a maple syrup as a raw material, which is diluted, pH-adjusted, and fermented to obtain the alcoholic drink. Wherein a sugar concentration of a fermentation liquid, which is made from the maple syrup that is diluted, does not exceed 22° Bx; and an alcohol content of a fermented alcoholic drink does not exceed 12% vol. Using finished maple syrup as fermentation raw material simplifies the brewing process, as it can be directly added to the brewing process, eliminating the need for a complex sugar conversion process. Nonetheless, adding the maple syrup necessitates maintaining optimal yeast fermentation; an inappropriate sugar concentration could disrupt this process. Excessively high sugar concentrations can suppress yeast metabolism, slowing fermentation, imposing osmotic stress on yeast cells, compromising their viability and activity, or even causing the death of yeast cells. By diluting maple syrup to form the fermentation liquid with a sugar concentration not exceeding 22° Bx, the present disclosure prevents the wastage of materials and ensures efficient fermentation.

In addition, a diluted liquid of maple syrup with a low sugar concentration implies lower sugar availability, potentially leading to insufficient fermentation, yielding fewer alcoholic drinks, which in turn can elevate production costs. Preferably, the sugar concentration of the fermentation liquid is 16-20° Bx; and the alcohol content of the fermented alcoholic drink is 6-12% vol.

In some embodiments, during the brewing process, sugars are not fully converted into alcohol and carbon dioxide but are instead deliberately subjected to interrupted fermentation. This process yields an alcoholic drink A with an alcohol content of 6-10% vol, and a sugar concentration of 3-8° Bx. The retention of unfermented sugars enhances the sweetness of the alcoholic drink, resulting in an alcohol content that is typically lower than that of fully fermented drinks. This method also preserves more of the original flavors and fresh aromas of the raw materials.

In some embodiments, in the brewing process, all fermentable sugars are converted into alcohol and carbon dioxide by a complete fermentation, resulting in alcoholic drink B with an alcohol content of 9-12% vol. The full conversion of sugars typically results in a dry-type alcoholic drink with a higher alcohol content and more developed fermentation-derived flavors.

The fermented maple syrup wines (the alcoholic drink A and the alcoholic drink B) have a clear body with an amber color, featuring the caramelized aroma of maple syrup and a round, soft palate, suitable for direct consumption.

In some embodiments, both the alcoholic drink A and the alcoholic drink B can be fortified with alcohol or spirits to adjust the alcohol content to 9-25% vol, and a sweetener is added to adjust the sugar concentration to 1-15° Bx. Then the alcoholic drink is stored in a maple wood barrel for aging to obtain a fermented sweet wine. The addition of alcohol or spirits allows for precise control over the final product's alcohol content to meet different consumer tastes and regulatory requirements, adding extra aroma and complexity to the fermented sweet wine. Moreover, adding alcohol can halt the fermentation process, saving time and preventing over-fermentation; a higher alcohol content also acts as a preservative, extending the product's shelf life. Sweeteners ensure a consistent and desired level of sweetness, crucial for maintaining product consistency and allowing producers to create various styles and types of sweet wines to meet diverse market demands.

In some embodiments, the sweetener is selected from one or more of maple syrup, malt syrup, high fructose syrup, glucose, sucrose, fructose, lactose, or honey.

When choosing sweeteners, considerations include the product's specific requirements, cost, flavor pairing, and target consumer preferences. Maple syrup and honey not only provide sweetness but also enhance the health image of the product due to the rich minerals in maple syrup and the nutritional value of honey. Additionally, high fructose syrup, known for its cost-effectiveness and cold sweetness, performs better in cold drinks. Malt syrup and sucrose can add to the texture and color of the product. When selecting a combination of various sweeteners, their synergistic effects can also be utilized to achieve the desired sweetness and flavor profile.

In some embodiments, additives can be added to the alcoholic drink obtained from fermentation to enhance its aroma and flavor. For instance, after fermentation, food-grade rose hydrosol can be added to give the alcohol a distinctive aroma and flavor.

In some embodiments, the alcoholic drink B is distilled to achieve an alcohol content of 60-70% vol. Distillation significantly increases the alcohol content in low-alcohol drinks, resulting in the production of high-proof spirits. This process not only concentrates the alcohol but also removes non-volatile impurities and, to some extent, concentrates and transforms the flavor compounds from the raw materials, creating a unique taste and aroma for the spirit.

The high-proof spirit obtained from distillation, referred to as a maple spirit, has a lighter style and a rich fragrance. To further enhance the uniqueness of the flavor and the palate fuller, both the fermented maple syrup wine and the distilled maple spirit are aged in maple wood barrels, developing more complex flavors and textures.

In some embodiments, the distilled spirit with an alcohol content of 60-70% vol can be adjusted to 40-60% vol by adding an ultrafiltered water or a low-proof alcohol during the production and bottling process of the spirit, resulting in a distilled spirit. This practice, often referred to as “reduction” or “dilution,” adds a suitable amount of water to mitigate the burning sensation of alcohol, balancing and softening the flavor, which helps to showcase the aroma and taste of the spirit.

In some embodiments, a method for preparing an alcoholic drink, the method comprises:
step (a): diluting a maple syrup with an ultrafiltered water to adjust a sugar concentration not exceeding 22° Bx, to form a fermentation liquid;
step (b): adding an acidity regulator to the fermentation liquid to adjust the pH to 3.0-5.0, and adding 0.3-0.5 g/L of a yeast nutrient to obtain a fermentation mash;
step (c): inoculating the fermentation mash with a yeast to ferment, to obtain a fermented alcoholic drink with an alcohol content not exceeding 12% vol.

Specifically, as the high sugar can suppress yeast metabolism, slowing fermentation, it is necessary to dilute the maple syrup with the ultrafiltered water to achieve the fermentation liquid with a sugar concentration not exceeding 22° Bx, creating the fermentation liquid suitable for fermentation. Then, food-grade acid regulators are used to adjust the pH of the fermentation liquid to meet the fermentation needs of yeast. Nutrients for yeast, such as amino acids, vitamins, and minerals, are added to create the fermentation mash to promote yeast growth. Brewing yeast is inoculated into the fermentation mash, initiating fermentation. The fermentation process, including the alcohol content, the residual sugar, and the pH values, is regularly monitored.

Preferably, the fermentation liquid, after dilution of maple syrup, should have a sugar concentration of 16-20° Bx. This ensures that the residual sugar after fermentation is low and the fermentation efficiency is relatively high. Consequently, the alcohol content of the fermented alcoholic drink is 6-12% vol.

Brewing requires a high-quality fermentation environment. Acetic acid bacteria in the air can easily cause the finished wine to taste sour, so it's necessary to keep the fermentation environment and related equipment clean before fermentation starts. Moreover, to prevent microbial spoilage and provide a favorable growth environment for brewing yeast, we adjust the pH of the fermentation liquid by adding citric acid or tartaric acid. The acidity, indicated by pH, generally shows that yeast ferments best under slightly acidic conditions. Considering production needs and the nature of maple syrup (free of excessive impurities), we decide to adjust the fermentation pH to 3.0-5.0. Using citric acid as an example, the addition amount is about 0.38 g/L-2 g/L.

Nitrogen is an essential nutrient during fermentation, but maple syrup lacks the nitrogen source needed for fermentation, which can improve the fermentation efficiency of yeast and speed up the conversion of sugar into alcohol and carbon dioxide. Diammonium phosphate as a nitrogen source because it results in the least amount of fusel oil, the highest alcohol content, and the best effect. Considering production costs and international usage requirements, we set the usage amount of diammonium phosphate to 500 mg/L, equivalent to providing 106 ppm of nitrogen.

One or more of the following combination processes can also be selected according to taste needs: clarification and filtration can remove suspended particles and impurities in the wine; pasteurization can interrupt fermentation and prolong the shelf life of alcoholic drinks by killing or reducing harmful microorganisms.

In some embodiments, in step (c), a fermentation temperature is maintained between 18-26° C. This temperature range is critical for influencing yeast activity, controlling microbial growth, and affecting flavor development. Operating within 18-26° C. enhances the metabolic rate of yeast, promoting alcohol production while preventing the growth of undesirable microbes, thus ensuring the quality and safety of the beverage. Additionally, different temperatures can either promote or inhibit the formation of certain flavor compounds, impacting the aroma and taste of the final product. At lower temperatures, and the alcohol content does not reach the expected outcome, with a taste that was too sweet and lacking in wine aroma, resembling fruit wine. Conversely, higher temperatures are deemed less suitable due to the overly rapid fermentation affecting the taste. Excessively high fermentation temperatures may also deactivate the yeast. Therefore, precise temperature control throughout the fermentation is essential for achieving optimal product quality.

In some embodiments, in step (c), sugars in the fermentation mash partially ferment to obtain an alcoholic drink A with an alcohol content of 6-10% vol, and a sugar concentration of 3-8° Bx. Sugars are not fully consumed by fermentation, the sweetness is retained, and the alcohol content that is typically lower than that of fully fermented drinks. This method also preserves more of the original flavors and fresh aromas of the raw materials.

In some embodiments, in step (c), sugars in the fermentation mash fully ferment for 7-15 days or even longer, and almost all the sugars in the fermentation mash are consumed, to obtain an alcoholic drink B with an alcohol content of 9-12% vol. Which is named a dry-type fermented wine.

In some embodiments, the alcoholic drink A and the alcoholic drink B, varying in fermentation levels or batches, exhibit distinct alcohol contents and sugar concentrations. These variations can be harmonized to a uniform style and flavor by adjusting.

Specifically, by adding alcohol or spirits, the alcohol content is adjusted to 9-25% vol, and by adding sweeteners, the sugar concentration is adjusted to 1-15° Bx, and then the fermented sweet wine is obtained through aging treatment.

In some embodiments, the method for preparing an alcoholic drink further comprises step (d): continuously distilling the alcoholic drink B using a column-type Husser integrated distiller to increase the alcohol content to 60-70% vol. The column-type Husser integrated distiller is a common distillation equipment, which combines the characteristics of pot still and column still, allows continuous feeding and discharging, improves production efficiency, and can obtain products of different concentrations and flavors by finely controlling distillation conditions.

In some embodiments, the distilled spirit with an alcohol content of 60-70% vol can be adjusted to 40-60% vol by adding an ultrafiltered water or a low-proof alcohol, mitigating the burning sensation of alcohol, balancing and softening the flavor, which helps to showcase the aroma and taste of the spirit. A distilled spirit is then produced by aging.

In some embodiments, the distilled spirit with an alcohol content of 60-70% vol can be firstly adjusted to 50-60% vol by adding an ultrafiltered water or a low-proof alcohol, and then after aging treatment, adjusting the alcohol content to 40-60% vol. The adjustment of the alcohol content is usually completed before aging to ensure that the product meets regulatory requirements and forms the desired flavor characteristics during the aging process. However, it can also be adjusted after aging to meet specific market demands or style characteristics.

In some embodiments, the aging is stored in a maple wood barrel. Aging significantly influences the enhancement of the flavor, texture, and overall quality of the wine. Barrels made from hard maple are rich in nutrients, including mainly sugars, vitamins, minerals, amino acids, etc, and also contain volatile organic compounds such as vanillin, ethyl coumarin, propionic aldehyde, phenolic compounds, quebec phenol, etc. Additionally, the density of hard maple is 625-753 kg/m³, comparable to the density of oak, 593-897 kg/m³, and hard maple, like oak, has excellent toughness, so we believe that it is feasible to use hard maple to make wine barrels.

Specifically, a temperature of 18° C. with a humidity of 75% is most suitable for aging.

We select hard maple trees over 200 years old from our farm, cut the wood according to the method used for oak barrels, and air-dry it for more than two years to reduce its moisture content. This process not only minimizes the risk of cracking and deformation but also lowers the likelihood of fungal growth. Such measures are crucial for enhancing the quality and longevity of the finished maple wood barrels. The cut hard maple wood is processed to produce ten 220-liter maple wood barrels. In five of these 220-liter maple wood barrels, we fill each with fermented sweet wines with the alcohol content of 14% vol made from maple syrup. The other five barrels are filled with fermented distilled spirits with the alcohol content of 60% vol. After three months, we take a 500 ml sample from each storage barrel to observe the results. The five barrels storing the 14% vol maple syrup fermented sweet wine have changed from their original light golden yellow to a deep golden yellow. The taste has incorporated the sweetness of the maple syrup, becoming sweet and rich, with a clear and transparent body. The other five barrels storing the 60% vol maple syrup distilled spirit have also undergone a change. The color has turned from colorless and transparent to amber. The spirit has been in full contact with volatile organic substances from the maple wood, such as vanillin, ethyl coumarin, propionic aldehyde, phenolic compounds, and quebec phenol, bringing a rich palate and unique aroma to the aged drink. the body is clear and transparent. The taste is distinctly different from rum aged in oak barrels, with the freshness of maple wood and the flavor of maple syrup, lacking any harshness upon entry, and leaving a sweet aftertaste with a full mouthfeel.

The finished steps are carried out by passing the respective original products through one of the following selective processes: clarification, filtration, heating, cooling, blending based on taste, or any combination of the above processes.

### BRIEF DESCRIPTION OF THE DRAWINGS

FIG. 1 is a process flowchart of alcoholic drink preparation with maple syrup as raw material in the present disclosure;

FIG. 2 is a schematic diagram of the alcohol content at different fermentation temperatures for Embodiment 2 in the present disclosure;

FIG. 3 is a schematic diagram of the density change during the fermentation for Embodiment 3 in the present disclosure.

### DETAILED DESCRIPTION

These and other objects, features and advantages of the present disclosure will become better understood with the following preferred embodiments, accompanying drawings and description in detail.

In the present disclosure, alcoholic drinks refer to drinks that contain an alcohol component, including all kinds of fermented wines, distilled spirits, prepared wines, and pre-mixed drinks.

The raw material maple syrup refers to finished maple syrup with 66% sugar concentration that has gone through the processes of collection, processing, and packaging, and is ready for direct use.

### Embodiment 1

Maple syrup is diluted with ultrafiltered water to obtain multiple fermentation liquids with sugar concentrations of 14° Bx, 16° Bx, 18° Bx, 20° Bx, and 22° Bx, respectively. To these liquids, citric acid is added to adjust the pH to between 3.0 and 5.0. Subsequently, 500 mg/L of diammonium phosphate (providing 106 ppm nitrogen) is introduced, followed by inoculating the liquids with activated wine yeast. The fermentation is conducted at 20° C. for a duration of 10-15 days. After fermentation, the alcohol content and the residual sugar level are measured, and the fermentation is documented. For details on the alcohol content and the residual sugar level after fermentation at different sugar concentrations, refer to Table 1.

In the present disclosure, the sugar concentration is expressed in Brix (° Bx), representing the grams of dissolved solids (primarily sugar) per 100 grams of liquid.

TABLE 1
Alcohol Content and Residual Sugar Level after
Fermentation at Different Sugar Concentrations

| Sugar Concentration | | |
|---|---|---|
| of the | | |
| fermentation | Alcohol | Residual Sugar |
| liquid/°Bx | Content/% vol | Level/°Bx |
| 14 | 8.2 | 0.2 |
| 16 | 9.3 | 0.3 |
| 18 | 10.5 | 0.2 |
| 20 | 11.7 | 0.3 |
| 22 | 11.9 | 1.8 |

The fermentation liquid with a sugar concentration of 14° Bx can be fermented into an alcoholic drink with an alcohol content of approximately 7-8.2% vol, and a residual sugar level between 0.2-0.9° Bx. Specifically, an alcohol content of 8.2% vol indicates complete fermentation, because the remaining 0.2° Bx shown by the Brix measurement actually consists of organic acids and other soluble substances. The alcohol degree attainable by complete fermentation is relatively low and may not meet the desired target.

The fermentation liquid with a sugar concentration of 16° Bx can be fermented into an alcoholic drink with an alcohol content of approximately 8-9.3% vol, and a residual sugar level between 0.3-1.2° Bx. Specifically, an alcohol content of 9.3% vol indicates complete fermentation, because the remaining 0.3° Bx shown by the Brix measurement actually consists of organic acids and other soluble substances.

The fermentation liquid with a sugar concentration of 18° Bx can be fermented into an alcoholic drink with an alcohol content of approximately 10-10.5% vol, and a residual sugar level between 0.2-1.0° Bx. Specifically, an alcohol content of 10.5% vol indicates complete fermentation, because the remaining 0.2° Bx shown by the Brix measurement actually consists of organic acids and other soluble substances.

The fermentation liquid with a sugar concentration of 20° Bx can be fermented into an alcoholic drink with an alcohol content of approximately 11-11.7% vol, and a residual sugar level between 0.1-1.3° Bx. Specifically, an alcohol content of 11.7% vol indicates complete fermentation, because the remaining 0.3° Bx shown by the Brix measurement actually consists of organic acids and other soluble substances.

The fermentation liquid with a sugar concentration of 22° Bx can be fermented into an alcoholic drink with an alcohol content of approximately 11-12% vol, and a residual sugar level between 1.6-3.3° Bx, indicating a relatively high level of residual sugars.

According to Table 1, multiple experiments on sugar concentration have demonstrated that maple syrup liquids with sugar concentrations between 16-20° Bx can meet the practical feasibility for production, avoiding the waste of excess maple syrup and ensuring complete and efficient fermentation. In practice, the desired alcohol content can dictate the selection of maple syrup's sugar concentration for fermentation.

### Embodiment 2

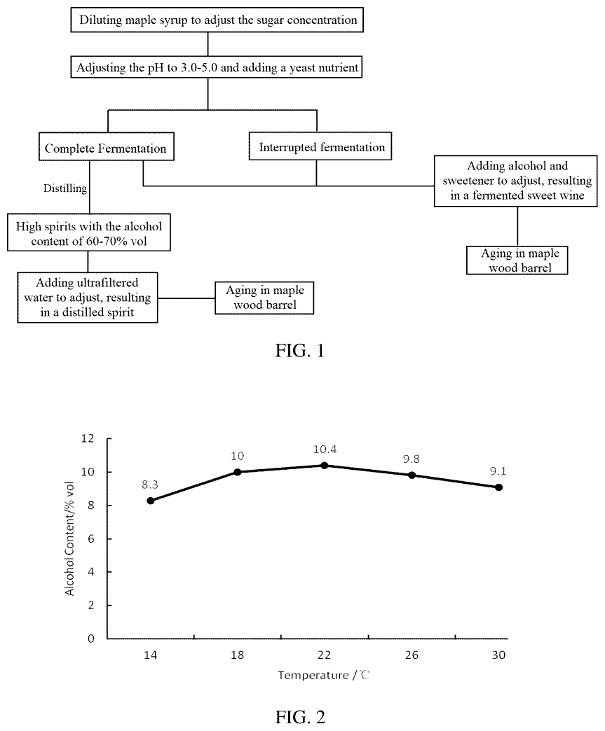

Maple syrup is diluted with ultrafiltered water to obtain multiple fermentation liquids with sugar concentrations of 18° Bx. To these liquids, citric acid is added to adjust the pH to between 3.0 and 5.0. Subsequently, 500 mg/L of diammonium phosphate (providing 106 ppm nitrogen) is introduced, followed by inoculating the liquids with activated wine yeast for the temperature experiment. The fermentation temperatures were 14° C., 18° C., 22° C., 26° C. and 30° C. respectively. After 7-15 days, sensory analysis and alcohol content measurements were performed on the fermentation products to select the most suitable temperature for production fermentation. The alcohol content corresponding to different fermentation temperatures is shown in FIG. 2, and the sensory analysis of the temperature experiment is shown in Table 2.

TABLE 2
Sensory Analysis after Fermentation at Different Temperatures

| Fermentation | Sensory |
|---|---|
| Temperature/° C. | Analysis |
| 14 | Pleasantly sweet and sour, |
| | light wine aroma, no off-flavors |
| 18 | Rich wine aroma, smooth, |
| | sweet without off-flavors, long |
| | aftertaste |
| 22 | Soft and balanced, |
| | pleasant wine aroma |
| 26 | Overall balanced, slightly tart, |
| | aftertaste with maple wine |
| | fragrance |
| 30 | Pronounced tartness and bitterness, |
| | thin wine aroma |

According to FIG. 2 and Table 2, at 14° C., the fermentation speed of maple syrup wine was slow, and the alcohol content did not reach the expected outcome, with a taste that was too sweet and lacking in wine aroma, resembling fruit wine. At 18° C., the fermentation speed was moderate, producing a wine with a higher alcohol content, rich in aroma, with a sweet fragrance and taste, smooth, without off-flavors, and a long aftertaste. The wine was amber in color and transparent. At 22° C., the fermentation speed was fast, yielding the highest alcohol content. The wine was well-balanced, with a pleasing aroma, slight acidity, but a long-lasting fragrance filling the mouth, and high visibility in its amber color. At 26° C., the fermentation speed was relatively fast, but the alcohol content showed a declining trend, and the taste was slightly sour and astringent, with a residual maple and wine fragrance. At 30° C., the wine fermented too quickly, ending the fermentation process prematurely, resulting in a wine that was not well-balanced, with noticeable acidity upon tasting, creating an unpleasant experience. In summary, the fermentation at 22° C. best matched the target outcome in terms of speed, alcohol content, taste, and color. The 30° C. fermentation condition was deemed less suitable due to the overly rapid fermentation affecting the taste. Consequently, 18-26° C. was selected as the optimal fermentation temperature range for maple syrup wine.

### Embodiment 3

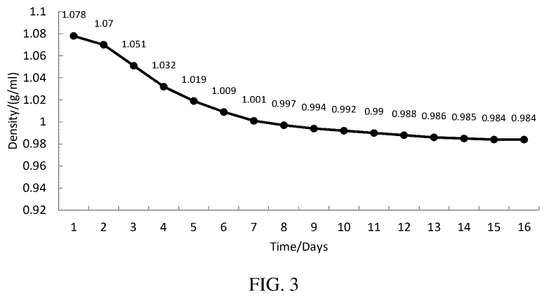

Maple Ridge Farm in Canada, in collaboration with Jin Wan Feng International Agricultural Products Deep Processing Technology (Shenzhen) Co., Ltd. and Emperor Wine Brewing Technology Research and Development Center, conducted a scale-up experiment. We prepare 2-ton and 5-ton fermentation tanks, and clean them with sterile water. Inject the maple syrup into the fermentation tank, add the ultra-filtered water to adjust the sugar concentration of the fermentation liquid to about 18° Bx, then add citric acid to adjust the pH of the fermentation liquid to 3.0-5.0. Next, add 0.5 g/L of diammonium phosphate fermentation aid from LAMOTHE ABIET company of France as a nitrogen source for the fermentation liquid. Inoculate the fermentation liquid with 0.25 g/L of wine yeast from LALLEMAND BIOFUELS & DISTILLED SPIRITS company of Switzerland, which has been activated in sterile water at 35-40° C. for 10-15 minutes. Place the fermentation tanks in an environment of 22° C. to ferment for about 16 days, monitoring the fermentation process throughout. The specific data is shown in FIG. 3. The density of the fermentation liquid is measured by comparing the mass ratio of the reaction liquid (such as the fermentation mash) to water.

According to FIG. 3, with the increase of fermentation days, the density of fermentation liquid continues to decline, and sugars are continuously consumed. The density of the fermentation liquid is the same on the 15th and 16th day of fermentation, indicating that complete fermentation has occurred by the 15th day.

To shorten the production cycle and achieve higher production efficiency, we do not use adsorbents like bentonite for the sedimentation of the fermentation liquid. Instead, we opt for more efficient modern membrane filtration technology. Hence, after fermentation ends, we perform coarse filtration using plate-and-frame filtration equipment, followed by membrane filtration technology to obtain a clear alcoholic drink. The flavor of the fermented wine can be enriched by adding or not adding maple syrup and other substances. Additionally, the scale-up experiment has demonstrated that fermenting an 18° Bx maple syrup liquid at 22° C. results in a wine that is amber in color, transparent, smooth in taste, free of off-flavors, and has a long aftertaste.

The completely fermented alcoholic drink is continuously distilled through the column-type Husser integrated distiller, to obtain the distilled spirit with an alcohol content of 60-70% vol. Then, the filtered distilled spirit is aged in maple barrels at a temperature of 18° C. and a humidity of 75%. After aging, the alcohol content is adjusted to 40-60% vol, filtered, and bottled to produce the final distilled spirit product.

### Embodiment 4

6 L of maple syrup with a sugar concentration of 66% is added to 18.2 L of ultrafiltered water, adjusting the sugar concentration of the fermentation liquid to approximately 20° Bx. Then, 24.2 g of citric acid is added to adjust the pH of the fermentation liquid to 4.6, followed by the addition of 12.1 g of diammonium phosphate from the French company LAMOTHE ABIET as the nitrogen source for the fermentation liquid. 6.05 g of wine yeast from the Swiss company LALLEMAND BIOFUELS & DISTILLED SPIRITS is activated in sterile water at 37° C. for 10 minutes and then inoculated into the fermentation liquid. The fermentation tank is placed at a temperature of 22° C. for fermentation for 15 days. Afterward, coarse filtration is performed using plate-and-frame filtration equipment, followed by membrane filtration technology to filter the fermentation liquid. Thus, a clarified raw wine is obtained with an alcohol content of 11.7% vol and a Brix measure of 0.3° Bx (the Residual Sugar Level was 0, 0.3° Bx for organic acids and other soluble substances).

### Embodiment 5

6 L of maple syrup with a sugar concentration of 66% is added to 18.2 L of ultrafiltered water, adjusting the sugar concentration of the fermentation liquid to approximately 20° Bx. Then, 24.2 g of citric acid is added to adjust the pH of the fermentation liquid to 4.6, followed by the addition of 12.1 g of diammonium phosphate from the French company LAMOTHE ABIET as the nitrogen source for the fermentation liquid. 6.05 g of wine yeast from the Swiss company LALLEMAND BIOFUELS & DISTILLED SPIRITS is activated in sterile water at 37° C. for 10 minutes and then inoculated into the fermentation liquid. The fermentation tank is placed at a temperature of 22° C. for fermentation for 14 days. Afterward, it is then continuously distilled using a column-type Husser integrated distiller, to obtain a distilled spirit with an alcohol content of 68% vol. Next, 0.6 L of ultrafiltered water is added to 0.9 L of the distilled spirit containing 68% vol alcohol, resulting in a distilled spirit with an alcohol content of 40% vol.

### Embodiment 6

Add 2.0 kg of maple syrup with a sugar concentration of 66%, to the 15 liters of clarified raw wine obtained by the method in Embodiment 4 to produce a fermented sweet wine containing 10.3% vol alcohol and 8° Bx of sugar. The wine is then aged in a maple barrel for three months, with a temperature of 18° C. and a humidity of 75%.

### Embodiment 7

Add 100 g of distilled spirit, which has an alcohol content of 68% vol, obtained from Embodiment 5, to the 1 kg of clarified raw wine obtained by the method in Embodiment 4. This process yields a dry fermented wine containing 15% vol alcohol. The wine is then aged in a maple barrel for one year at a temperature of 18° C. and a humidity of 75%.

### Embodiment 8

Add 100 g of distilled spirit, which has an alcohol content of 68% vol, obtained from Embodiment 5, to the 1 kg of clarified raw wine obtained by the method in Embodiment 6, to produce a fermented sweet wine containing 15% vol alcohol and 8° Bx sugar. The wine is then aged in a maple barrel for three months at a temperature of 18° C. and a humidity of 75%.

### Embodiment 9

The distilled spirit with an alcohol content of 40% vol obtained in Embodiment 5 is aged in a maple barrel for one year at a temperature of 18° C. and a humidity of 75%.

### Embodiment 10

Add 4 g of food-grade rose hydrosol to the 1 kg fermented sweet wine obtained in Embodiment 6 to produce a fermented, flavored sweet wine containing 10.3% vol alcohol.

### Embodiment 11

6 L of maple syrup with a sugar concentration of 66% is added to 18.2 L of ultrafiltered water, adjusting the sugar concentration of the fermentation liquid to approximately 20° Bx. Then, 24.2 g of citric acid is added to adjust the pH of the fermentation liquid to 4.6, followed by the addition of 12.1 g of diammonium phosphate from the French company LAMOTHE ABIET as the nitrogen source for the fermentation liquid. 6.05 g of wine yeast from the Swiss company LALLEMAND BIOFUELS & DISTILLED SPIRITS is activated in sterile water at 37° C. for 10 minutes and then inoculated into the fermentation liquid. The fermentation tank is placed at a temperature of 22° C. for fermentation for 6 days. Afterward, take out the 1 kg fermentation mash for pasteurization to interrupt the fermentation, and obtain a fermented sweet wine with an alcohol content of 7.5% vol and a sugar concentration of 7.2° Bx.

Although the present disclosure has been described in considerable detail with reference to certain preferred embodiments thereof, the disclosure is not to limit the scope of the present disclosure. Persons having ordinary skill in the art may make various modifications and changes without departing from the scope and spirit of the present disclosure. Therefore, the scope of the appended claims should not be limited to the description of the preferred embodiments described above.

What is claimed is:

1. An alcoholic drink, comprising:
a maple syrup as a raw material, which is diluted, pH-adjusted, and fermented to obtain the alcoholic drink;
wherein a sugar concentration of a fermentation liquid, which is made from the maple syrup that is diluted, does not exceed 22° Bx;
an alcohol content of a fermented alcoholic drink does not exceed 12% vol.

2. The alcoholic drink according to claim 1, wherein the sugar concentration of the fermentation liquid is 16-20° Bx; and
the alcohol content of the fermented alcoholic drink is 6-12% vol.

3. The alcoholic drink according to claim 2, wherein an alcoholic drink A is obtained by an interrupted fermentation, with an alcohol content of 6-10% vol, and a sugar concentration of 3-8° Bx.

4. The alcoholic drink according to claim 3, wherein an alcohol or a spirit is added to the alcoholic drink A to adjust the alcohol content to 9-25% vol, and a sweetener is added to adjust the sugar concentration to 1-15° Bx.

5. The alcoholic drink according to claim 2, wherein an alcoholic drink B is obtained by a complete fermentation, with an alcohol content of 9-12% vol.

6. The alcoholic drink according to claim 5, wherein an alcohol or a spirit is added to the alcoholic drink B to adjust the alcohol content to 9-25% vol, and a sweetener is added to adjust the sugar concentration to 1-15° Bx.

7. The alcoholic drink according to claim 5, wherein the alcoholic drink B is distilled, to increase the alcohol content to 60-70% vol.

8. The alcoholic drink according to claim 7, wherein an ultrafiltered water or a low alcohol content drink is added to the alcoholic drink to adjust the alcohol content to 40-60% vol.

9. The alcoholic drink according to claim 8, wherein the alcoholic drink is stored in a maple wood barrel for aging.

10. A method for preparing an alcoholic drink, the method comprising:
step (a): diluting a maple syrup with an ultrafiltered water to adjust a sugar concentration not exceeding 22° Bx, to form a fermentation liquid;
step (b): adding an acidity regulator to the fermentation liquid to adjust the pH to 3.0-5.0, and adding 0.3-0.5 g/L of a yeast nutrient to obtain a fermentation mash;
step (c): inoculating the fermentation mash with a yeast to ferment, to obtain a fermented alcoholic drink with an alcohol content not exceeding 12% vol.

11. The method according to claim 10, wherein in step (c), a fermentation temperature is 18-26° C.

12. The method according to claim 11, wherein the sugar concentration of the fermentation liquid is 16-20° Bx; and the alcohol content of the fermented alcoholic drink is 6-12% vol.

13. The method according to claim 12, wherein in step (c), sugars in the fermentation mash partially ferment to obtain an alcoholic drink A with an alcohol content of 6-10% vol, and a sugar concentration of 3-8° Bx.

14. The method according to claim 13, wherein an alcohol or a spirit is added to the alcoholic drink A to achieve an alcohol content of 9-25% vol, and the sweetener is added to achieve a sugar concentration of 1-15° Bx, followed by aging to obtain a fermented sweet wine;
wherein the aging is stored in a maple wood barrel.

15. The method according to claim 12, wherein in step (c), sugars in the fermentation mash completely ferment to obtain an alcoholic drink B with an alcohol content of 9-12% vol.

16. The method according to claim 15, wherein an alcohol or a spirit is added to the alcoholic drink B to achieve an alcohol content of 9-25% vol, and the sweetener is added to achieve a sugar concentration of 1-15° Bx, followed by aging to obtain a fermented sweet wine.

17. The method according to claim 16, wherein the aging is stored in a maple wood barrel.

18. The method according to claim 15, further comprising step (d): continuously distilling the alcoholic drink B using a column-type Husser integrated distiller to increase the alcohol content to 60-70% vol.

19. The method according to claim 18, wherein an ultrafiltered water or a low alcohol content drink is added to adjust the alcohol content to 40-60% vol, followed by aging to obtain a distilled spirit.

20. The method according to claim 19, wherein the aging is stored in a maple wood barrel.
